(19) United States
(12) Patent Application Publication
(10) Pub. No.: US 2003/0057697 A1
(43) Pub. Date: Mar. 27, 2003

(54) Staple fasteners with color and other indicia features and use thereof

(76) Inventor: Landon Duval, Huntington Beach, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/020,550

(22) Filed: Oct. 30, 2001

(51) Int. Cl. B42D 9/00

(52) U.S. Cl. 281/42

(57) ABSTRACT

A staple fastener comprises an elongate wire having a generally uniform cross section, and is bent to form a U-shape having a pair of linear spaced apart parallel leg portions depending from a common linear backbone portion. The staple fastener has an outer surface colored using a chemical surface treatment such as a chromate conversion coating. The staple fastener binds a document of the same color for hiding the fastener, or of a contrasting color for coding the document for improved filing efficiency and the color may carry significance in other respects, such as blue for the Engineering Department, green for the Marketing Department, red for the Manufacturing Department, and white for Management. The fastener may be multicolor when such would have significance, i.e., red, white and blue. The fastener may also carry an indicia which may be a code, such as a name or number or the like for improved disposition of the document and for filing. Such indicia may relate to filing location, routing or destination identification.

### BACKGROUND OF THE INVENTION

1. Field of the Invention

This invention relates generally to stable fasteners and more particularly to such staple fasteners having novel indicia properties synergistic with improved document handling methods.

2. Description of Related Art

The following art defines the present state of this field:

Nalepka et al., U.S. Pat. No. D374,892 describes a set of color coded labels for organizing books.

Purdy, U.S. Pat. No. 3,914,824 describes a system for organizing groups or sets of related papers in which a plurality of substantially identical, interconnectable paper clips are provided. Each clip is capable of receiving and retaining a single set or group of papers, and is provided with lateral or vertical interconnecting elements for connection to a like paper clip with the connecting elements being positioned so as to dispose the various interconnected clips and their associated retained sets of papers in segregated but connected, spaced-apart parallel planes forming a terrace-like or vertical stick array. The individual paper clips may be indexed, such as by labeling, color coding or other indexing devices to facilitate the identification of the individual groups of papers in the interconnected array.

Villa-Real, U.S. Pat. No. 4,389,755 describes an improved paper clip for clipping a plurality of paper work wherein the front face portion of the clip has a laterally extending area to accommodate informational or instructional indicia which can be changed or updated according to the organizational needs of the user. An integrally formed hook structure is also provided in one embodiment to permit hanging the clips and paper work on a supporting structure.

Harper, U.S. Pat. No. 5,272,792 describes a paper clip to secure a plurality of sheets of paper which are located in juxtaposition. The paper clip includes a rigid sheet material metallic body which is bendable and when bent remains in the bent position. The body is to be bent into a pair of wings of substantially equal size that are to be located against the back side of the sheets of paper with the sheets of paper being bound between the wings and the front of the body. These wings are to be bent over toward the front clamping the sheets of paper between the wings and the front. The body includes a plurality of ridges for tightly pressing the sheets of paper facilitating securement. The body can be manufactured in any one of variety of colors.

Kim, U.S. Pat. No. 5,395,137 describes a color code label including a base member, a thin plate; a color code coated attached to the surface of the base member and on which color bands are arranged and printed in different colors; and a coating layer which covers the surface of the color code with opaque or semitransparent materials and is removable to expose make a desired portion of the color bands exposed, for information classification or identification. Used with any kind of information keeping structure including cords, files, binders, material cases, envelopes, jackets, the label helps users handle documents easy and fast.

Curry, U.S. Pat. No. 5,620,289 describes colored staples with color identification components. A plurality of staples is provided. Each such plurality has a central section in a first plane and end sections in planes spaced parallel with each other and perpendicular to the first plane. The staples have a common cross-sectional configuration throughout the majority of their extents and are formed with points at the ends of their ends remote from their central sections. Each plurality of the staples has a generally rectangular cross-section with parallel interior and exterior faces and parallel lateral faces therebetween. A plurality of cylindrical sleeves, one for each staple, are provided. Each sleeve has an interior opening of a rectangular cross-sectional configuration of a size and shape corresponding to the cross-sectional configuration of the staples and mounted thereon to cover essentially the entire central section. The color of the sleeves are constant for the plurality of staples to assist in identification purposes.

Cunningham, WO 82/01165 describes a color-coded filing system for uniquely identifying documents to be filed and retrieved. The document to be filed has sequential filing characters applied along the top and side edges thereof. Marker tabs are provided which are pressure sensitive, adhesive backed and transparent and have a colored peripheral border that defines a two position transparent aperture. A positively applied filing character is provided in the first position of the tab aperture and the second position of the marker tab is over the filing characters on the document so that the characters on the document appear in the second position of the tab aperture next to the characters on the tab. Both characters are of a similar size, color and shape so as to provide a unique and visually acceptable identification for said document. The filing characters can be either numerals or letters which can be used on the top of side edge of the document for drawer or shelf filing.

The prior art teaches the use of colored staples but does not teach the colorization of a staple as a means for identification of storage location and other coded objectives such as where a document is intended to be taken, the means of travel, the path of travel, and so forth. The present invention fulfills these needs and provides further related advantages as described in the following summary.

### SUMMARY OF THE INVENTION

The present invention teaches certain benefits in construction and use which give rise to the objectives described below.

A staple fastener of the piercing type, comprises an elongate wire having a generally uniform cross section, and is bent to form a U-shape having a pair of linear spaced apart parallel leg portions depending from a common linear backbone portion. The staple fastener has an outer surface colored using a chemical surface treatment such as a chromate conversion coating. Such a coating converts the surface atoms of the base material to a compound that may have any one of a wide range of selected colors. It's primary advantage, in a staple, is that it does not add appreciably to the bulk of the fastener, so that existing staple fastener stocks, and stapling machines may be utilized without modification. A further advantage of this approach is that the staple's legs, when bent or formed in the stapling process, do not result in a cracked or crazed surface, as is found with thick coatings. A still further marked advantage to this type of colorizing of layer piercing staples is that the chromate conversion coating process, when conducted for pale tints on steel and aluminum, is a very low cost and simple process. In one approach of the present invention, the staple fastener binds a document of the same color, generally a pale tint, for hiding the fastener. In another approach, a contrasting color is used for coding the document for improved filing efficiency. The staple's color may carry significance in respect to document destination when it is moved between offices, and as to the proposed routing. The fastener may be multicolor when such would have significance, i.e., red, white and blue. The fastener may also carry an indicia such as a name or the like for improved directing of the document and for filing. This is easily accomplished by stamping a making ink onto the staple fastener prior to colorizing it. A combination of the document so fastened may be color or indicia coded to match a storage place or a destination place such as a department, floor, building, folder or a draw.

A primary objective of the present invention is to provide a document fastener and method of use of such fastener that provides advantages not taught by the prior art.

Another objective is to provide such a fastener capable of binding a document while blending with the colors of the document itself.

A further objective is to provide such an invention capable of providing a meaningful statement through color relationships.

A further objective is to provide such an invention capable of company, organization, State, country, product, program, project, chemical, automobile, aircraft, or building identification.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of plural documents, each bound by a staple fastener according to the invention, each of a selected color, the colors contrasting with the colors of documents bound thereby;

FIG. 2 is a plan view of a staple fastener according to the invention, having a color matching and thereby being camouflaged on the document bound thereby;

FIG. 3 is a document bound by a staple fastener according to the invention, having indicia recorded thereon;

FIG. 4 is a perspective view of plural staple fasteners according to the invention, each distinguished by a color indicia;

FIG. 5 is a staple fastener according to the present invention having plural colors thereon; and

FIG. 6 is a document storage means providing indicia corresponding to a staple fastener according to the present invention.

### DETAILED DESCRIPTION OF THE INVENTION

The above described drawing figures illustrate the invention in at least one of its preferred embodiments, which is further defined in detail in the following description.

This present invention, as shown generally in FIG. 5, is a staple fastener 5 for paper or other materials, comprising an elongate wire of any structural material and preferably steel, the wire having a generally uniform cross section, round, square, rectangular, etc., and bent to form a U-shape having a pair of linear spaced apart parallel leg portions 10 depending orthogonally from a common linear backbone portion 20. The staple fastener 5 has an outer colored surface 25 formed using a chemical surface treatment, such as a chromate conversion coating. This coating is preferably of the Iridite® process type formulated by the MacDermid Corportion and may be produced in a wide variety of colors and shades as is well known in industry. This type of process converts an outer layer of atoms of the base material to a chromate and does not add appreciable to the bulk or outer dimensions of the base material. In this respect it is ideal for coloring staples without the need for changing well known and common staple stocks for the staple machines that they are dispensed from. FIG. 4 shows that staple fasteners 5 may be colored with different colored coatings: 25′, 25″ and 25′″.

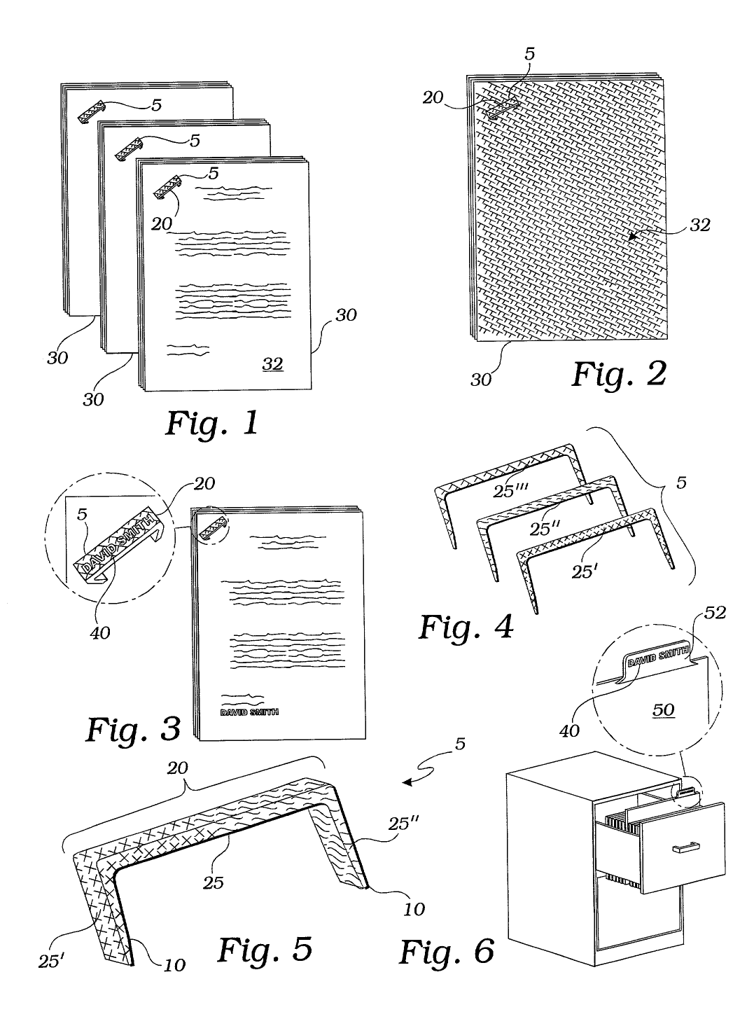

In one embodiment, shown in FIG. 2, the staple fastener 5 is used to bind a document 30 comprised of a sheath of papers, by a universally well-known stapling process wherein the backbone portion 20 of the staple fastener 5 is visible on a topmost sheet 32 of the document 30. In this embodiment, the topmost sheet 32 of the document 30 is colorized to match the colored staple fastener 5 so that the staple fastener backbone 20 blends visually with the topmost sheet 32 of the document 30, and therefore presents a neat appearance, and it is unlikely that the staple fastener is easily noticed. An example of this approach is to use an off-white colored staple 5 with a matching off-white stationery paper sheet 32. In a similar manner the topmost sheet 32 may be colorized to contrast with the color of the fastener 5, as shown in FIG. 1, so that the backbone portion 20 is visually noticeable relative to the topmost sheet 32. For instance, during Christmas season, when the colors; Red and Green, are prevalent, a document having the topmost sheet 32 in a light shade of green, is advantageously matched to a deep red colored staple fastener 5. Likewise, the staple fastener 5 may be provided with plural colorized coated segments having colors 25′ and 25″, as shown in FIG. 5, and these may be of significance to those using the document 5. For instance, national flag colors, such as red, white and blue for the United States of America and red and white for Canada would have significance to those reading a document with a patriotic theme.

In a similar manner the staple fastener 5, may be printed with a recognizable indicia 40 on the backbone portion 20, by the simple additional step of masking the surface prior to the colorization process so that the indicia 40 is clearly visible as non-colored portions. The indicia 40 may be a written name (FIG. 3) or a code number made up of recognizable characters such as numbers, letters, symbols and combinations of these. Such indicia 40 beneficially may relate to identification of a file folder location, such as a file cabinet, a file folder, a drawer, a shelf and the like so that the document may be easily and more accurately matched with its proper place of storage. In this manner a file folder 50, (FIG. 6) for example, having a file folder tab 52, may be marked with the indicia 40 or be colored in a manner corresponding to the color of the staple fastener 5, for instance with colors 25′ or 25″, whereby improvements toward the goal of error-free filing may be possible when a filing clerk matches the staple fastener indicia 40 and/or color with the indicia 40 and/or color of the file folder tab 52 or other file storage place.

Clearly, it should be understood that the nature of the fastener coding (indicia characters or color, etc.) may be related to a file location. Such coding is carried out today with press-on tabs and the like that are manually attached to documents. However, the present invention moves the state of this art forward since the staple itself may be the coded item so that additional time, cost and errors can be avoided by dispensing with any additional step of coding a document after it has been stapled, i.e., the staple 5 acts as a fastener, identification device and a storage locating or directing device.

A corresponding method of the present invention results in improving the appearance of a document by coloring the exterior surface of the staple fastener 5, coloring a topmost sheet 32 of the document to match the colored staple fastener 5, and binding the document 30 with the colored staple fastener 5 so that the staple fastener 5 is not easily noticed on the document 30. This enables the document 30 to have an improved appearance without using more costly binding methods and hardware.

In a further associated method the staple fastener 5 is used to bind a document 30, and then the document is placed into a file folder 50 having a colored tab 52 to match the colored staple fastener 5. A still further associated method comprises imprinting an indicia 40 on an exterior surface of the staple fastener 5, binding the document 30 with the staple fastener 5, and then filing the document in a file folder 50 having a tab 52 carrying a tab indicia 40 corresponding to the indicia 40 of the staple fastener 5.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A staple fastener comprising: an elongate wire having a generally uniform cross section, the elongate wire bent to form a U-shape having a pair of linear spaced apart parallel leg portions depending orthogonally from a common linear backbone portion, the elongate wire modified by a chemical surface treatment resulting in selectively coloring the elongate wire without appreciably increasing dimensions of the uniform cross section thereof, the chemical surface treatment of a type enabling the leg portions to be bent in a stapling process without cracking or crazing.

2. The staple fastener of claim 1 wherein the chemical surface treatment is a chromate conversion coating.

3. The staple fastener of claim 2 wherein the chromate conversion coating is an Iridite® process.

4. The staple fastener of claim 1 further comprising, in combination therewith, a document bound by the staple fastener via the stapling process wherein the backbone portion of the staple fastener is visible on a topmost sheet of the document.

5. The combination of claim 4 wherein the topmost sheet of the document is colorized to match the colored staple fastener so that the staple fastener backbone blends visually with the document, whereby a neat appearance is achieved.

6. The combination of claim 4 wherein the topmost sheet of the document is colorized to contrast in color with the colored staple fastener so that the staple fastener backbone is visually noticeable relative to the document, whereby the document is visually coded.

7. The staple fastener of claim 1 wherein the backbone portion provides plural colorized segments, whereby color combinations of significance may be employed.

8. The staple fastener of claim 7 wherein the plural colorized segments correspond to national flag colors.

9. The combination of claim 4 wherein the backbone portion of the staple fastener carries a recognizable indicia comprised of one of: numbers, letters, symbols and combinations thereof, the indicia corresponding to portions of the staple fastener void of the surface treatment.

10. The combination of claim 9 wherein the recognizable indicia relates to a document storage location.

11. The combination of claim 10 further comprising in the combination, a document storage location marked with a storage indicia corresponding to the indicia of the staple fastener, whereby filing accuracy is improved by matching the staple fastener indicia with the indicia of the storage location.

12. The combination of claim 4 wherein the color of the colored surface of the staple fastener corresponds to a color marking on a document storage location.

13. The combination of claim 12 wherein the document storage location is a file folder with a colored file folder tab.

14. A method of improving the appearance of a document comprising the steps of: coloring an exterior surface of a staple fastener with a colorizing chemical surface treatment without adding to the cross sectional dimensions of the fastener; coloring a topmost sheet of a document to match the colored staple fastener; and binding the document with the colored staple fastener so that the staple fastener is not easily noticed on the document.

15. A method of filing comprising the steps of: coloring an exterior surface of a staple fastener with a colorizing chemical surface treatment without adding to the cross sectional dimensions of the fastener; binding a document with the staple fastener, and filing the document in a storage place having a color matching that of the colored staple fastener.

16. A method of filing comprising the steps of: coloring an exterior surface of a staple fastener with a colorizing chemical surface treatment without adding to the cross sectional dimensions of the fastener and leaving voids thereof, the voids recognizable as an indicia; binding a document with the staple fastener in a manner such that the indicia is visible, and filing the document in a storage place providing a storage place indicia corresponding to the indicia of the staple fastener.
